(19) United States
(12) Patent Application Publication
(10) Pub. No.: US 2018/0178249 A1
(43) Pub. Date: Jun. 28, 2018

(54) SURFACE TEXTURE DESIGN FOR STABLE SOLID-AIR-LIQUID COMPOSITE INTERFACES AND METHODS OF MAKING

(71) Applicant: ExxonMobil Research and Engineering Company, Annandale, NJ (US)

(72) Inventors: Ning MA, Whitehouse Station, NJ (US); Qiuzi LI, Clinton, NJ (US); Robert J. COLBY, Annandale, NJ (US); Srinivasan RAJAGOPALAN, Easton, PA (US)

(21) Appl. No.: 15/838,632

(22) Filed: Dec. 12, 2017

Related U.S. Application Data
(60) Provisional application No. 62/438,496, filed on Dec. 23, 2016.
(60) Provisional application No. 62/438,498, filed on Dec. 23, 2016.

(51) Int. Cl. B05D 5/10; B29C 59/16; B29C 59/02; G01N 25/18

(52) U.S. Cl. CPC B05D 5/10; G01N 25/18; B29C 59/022; B29C 59/16

(57) ABSTRACT

Described herein is an integrated approach towards design of surfaces for stable wettability regimes with various liquids. The approach comprises a designing component used to calculate stable thermodynamic configurations associated with different wettability states, and an experimental component that allows for manufacturing of different surfaces with re-entrant texture features as calculated by the modeling approach.

### CROSS-REFERENCE TO RELATED APPLICATIONS

This application claims the benefit of U.S. Provisional Application No. 62/438,496, filed on Dec. 23, 2016, the entire contents of which are incorporated herein by reference.

This application also claims the benefit of co-pending U.S. Provisional Application No. 62/438,498, filed on Dec. 23, 2016, the entire contents of which are incorporated herein by reference.

### FIELD

The description provides an integrated approach towards design of surfaces for stable wettability regimes with various liquids. The approach comprises a designing component used to calculate stable thermodynamic configurations associated with different wettability states, and an experimental component that allows for manufacturing of different surfaces with re-entrant texture features as calculated by the modeling approach.

### BACKGROUND

Interactions at solid-liquid interfaces are governed by the relative surface energies of the solid and liquid phase(s). The ability to modify these surface energies through modification of the solid surface offers the ability to control and manipulate the interactions and resultant properties, e.g., wettability of the liquid(s) on the solid surface in consideration. In addition, other related processes such as adsorption (of liquid) or other solids (that may exist in the liquid phase) can be controlled.

The basic theory behind solid-liquid surface interactions can be traced back to the Young's equation, which gives a simple energy balance to explain how liquids may wet a solid surface. The Young's equation essentially states that wettability is governed entirely by surface energies, or in other words, through surface chemistry. Later on, modifications to Young's equation were provided (by Wenzel and Cassie-Baxter) to incorporate the effects of surface roughness and texturing.

In the Wenzel state, the liquid is in intimate contact with a textured surface. The surface roughness increases the available surface area of solid, thus amplifying the natural wettability state offered by surface chemistry. In this case, a hydrophobic surface becomes more hydrophobic than the original surface without roughness, and similarly, a hydrophilic surface becomes more hydrophilic than the “smooth” surface. In addition, the large contact area between liquid and solid leads to high contact angle hysteresis, defined as the difference between the advancing and receding contact angles. Liquid droplets, thus, do not readily roll off the textured surface. In the Cassie-Baxter (CB) state, air trapped in the grooves between surface features (i.e. a textured or patterned surface) forms a composite (solid/air/liquid) surface. By contrast, the composite interface could produce a hydrophobic surface on otherwise unpatterned/non-textured, hydrophilic substrates, and also facilitates easy droplet roll off. The CB state is thus desirable for many applications such as self-cleaning surfaces and microfluidics.

It has been understood that the functionalized surface depends on both the surface texture and surface energy, i.e. the micro/nanostructures on the surface and modification of surface energy level by chemical substance. While the chemical modification is a quite developed area covering a variety of commercialized material systems such as epoxy coatings, diamond-like coatings and thermal spray alumina coatings, among several others, surface texture modification is still a very active research topic. A relatively simple surface texture was fabricated and demonstrated its effectiveness by displaying contact angles with organic liquid greater than 150° and low contact angle hysteresis. But limited effort has been identified towards the achievement of stable CB state for pressure critical applications. With the advancement in surface fabrication technologies, the present disclosure describes approaches for a novel surface texture design to achieve composite interface and enhance its stability, and the method of fabricating texture on a variety of materials including but not limited to metallic surfaces.

### SUMMARY

The present disclosure relates to an approach for optimal texture design to produce stable composite interface and the method of making. The applications include, but are not limited to, step-out corrosion resistance, self-cleaning, anti-icing and heat transfer.

In one aspect, the description provides a method of designing a composite interface for manipulating wettability of a single liquid when in contact with the surface including steps of calculating stable thermodynamic energy associated with different wettability states; integrating the stable thermodynamic energy of all surfaces; identifying the candidate surface texture to achieve the composite interfaces; and increasing composite interface pressure tolerance by at least one of reducing the length scale of structure texture features, increasing liquid/air interface anchor points, and introducing locked air pockets.

In certain embodiments, the method further comprises identifying the height, shape, and spacing of the candidate surface texture. In certain embodiments, the method further comprises the step of assessing the candidate surface texture; and/or selecting a manufacturing method to produce the candidate surface texture.

In another aspect, the description provides a method of producing a composite interface for manipulating wettability of a single liquid in contact with that surface including steps of: calculating stable thermodynamic energy associated with different wettability states; integrating the stable thermodynamic energy of all surfaces; identifying the candidate surface texture to achieve the composite interfaces; increasing composite interface pressure tolerance by at least one of reducing the length scale of structure texture features, increasing liquid/air interface anchor points, and introducing locked air pockets; and fabricating the candidate surface texture using the manufacturing method.

In certain embodiments, the method further comprises identifying the height, shape, and spacing of the candidate surface texture. In certain embodiments, the candidate surface texture comprises multiple spherical features stacking on top of each other.

In certain embodiments, the candidate surface texture has a minimum feature size of 50 μm. In certain embodiment, the candidate surface texture with a minimum feature size of 50 μm is fabricated using an additive manufacturing method. In another embodiments, the candidate surface texture has a maximum feature size of 50 μm. In certain embodiment, the candidate surface texture with a maximum feature size of 50 μm is fabricated using a lithography-based method.

The description further provides a lithography-based method including steps of coating a surface with alternative layers of materials A and B, wherein materials A and B are chosen from a group of materials consisting of, e.g. silicon, silicon nitride, silicon dioxide, or other ceramic oxides, carbides, borides, sulfides, fluorides, nitrides, and metallic materials, wherein materials A and B have different etching rates; etching using a nominally isotropic method to create a primary pattern on the vertical directions of the layers of materials A and B; and etching using an anisotropic method to reveal a texture on the scale of the AB layer thickness on the sidewalls of the primary pattern.

In another embodiment, the description provides a composite interface produced according to the methods described herein, including, e.g., a surface texture with an array of multiple spherical features stacked on top of each other.

In another aspect, the description provides an article with at least one surface prepared according to the methods described herein, wherein the surface has a static contact angle with a single liquid of from between 0 degrees and about 170 degrees, preferably with a stable static contact angle of between about 10 degrees and about 170 degrees between an applied pressure range from about 1 psi to about 5000 psi.

In yet another embodiment, the description provides a device comprising at least one surface prepared according to the methods described herein, wherein the surface has a static contact angle with a single liquid of between 0 degrees and about 170 degrees, preferably a stable static contact angle of between about 10 degrees and about 170 degrees between an applied pressure range from about 1 psi to about 5000 psi.

Where applicable or not specifically disclaimed, any one of the embodiments described herein are contemplated to be able to combine with any other one or more embodiments, even though the embodiments are described under different aspects of the disclosure.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE FIGURES

FIG. 1 illustrates Cassie-Baxter wetting state under two θ_{γ} values. The local equilibrium criteria requires re-entrance texture when θ_{γ}<90°.

FIG. 2 illustrates the concepts to improve surface CB state stability without affecting its hydrophobicity.

FIG. 3 illustrates (a) Metlab energy landscape output for surface with sphere texture and θ_{γ}=120° with G being the gibbs free energy density (J/m2) and Gₘᵢₙ being the minimum in G. The critical design parameter including Wenzel, CB states and energy barrier are labeled; (b) energy profile for transition between CB and Wenzel states.

FIG. 4 illustrates the improved energy barrier between CB and Wenzel states using the proposed “snowman” surface texture.

FIG. 5 illustrates the plot of the breakthrough pressure as a function length scale. 1/10 of micrometer is required to achieve 1 bar breakthrough pressure.

FIG. 6 illustrates a schematic drawing of a top down view of surface texture showing the concept of locking air pocket using thin walls design. Oil can be added to further stabilize the composite interface.

FIG. 7 illustrates the concept of fabricating metallic surface texture in length scale of 50 μm using additive manufacturing.

FIG. 8 illustrates the concept for creating texture on multiple length-scales using a multilayered coating with a non-selective etch to create larger-scale texture followed by a selective etch to create smaller scale features on the sides of the larger-scale features.

FIG. 9 illustrates the concept for a coaxial pipeline with a porous patterned layer separating the media flowing in the core of the pipe from a second phase contained along the walls, in which it is possible to alter the flow and/or pressure of the outer layer to effect wetting, adhesion, or flow.

FIG. 10 illustrates the workflow for design of textured and/or patterned surfaces (D1).

FIG. 11 illustrates the manufacturing workflow for textured/patterned surfaces (M1).

FIG. 12 illustrates (a) a side view of a single snowman surface texture fabricating using AM technology; (b) snowman array used for water contact angle measurement.

### DETAILED DESCRIPTION

Presently described are methods of designing and making surfaces having an optimal surface texture with stable composite interface. The approach comprises a designing component used to calculate stable thermodynamic configurations associated with different wettability states, and an experimental component that allows for manufacturing of different surfaces with re-entrant texture features as calculated by the modeling approach.

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the invention. All publications, patent applications, patents, figures and other references mentioned herein are expressly incorporated by reference in their entirety.

It should also be understood that, unless clearly indicated to the contrary, in any methods claimed herein that include more than one step or act, the order of the steps or acts of the method is not necessarily limited to the order in which the steps or acts of the method are recited.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The term “about” or “approximately” means an acceptable error for a particular value as determined by one of ordinary skill in the art, which depends in part on how the value is measured or determined. All numerical values within the detailed description and the claims herein are modified by “about” the indicated value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein, unless the context indicates otherwise, the term “surface roughness” or “roughness” (R) is used in reference to a surface feature of a manufactured item, e.g., a metallic or alloy component, such as, e.g., for use in a mechanical system. R is quantified by the deviations in the direction of the normal vector of a real surface from its ideal form. If these deviations are large, the surface is rough; if they are small, the surface is smooth.

As used herein, unless the context indicates otherwise, the term “contact angle” is the angle between the solid and liquid surfaces. Wetting is characterized by the contact angle. If the liquid or oil wets the surface (referred to as a hydrophilic/oleophilic surface), the value of the contact angle is 0°<θ<90°, whereas, if the liquid or oil does not wet the surface (referred to as a hydrophobic/oleophobic surface), the value of the contact angle is 90°<θ<180°. The term hydrophobic/philic, which was originally applied only to water, is often used to describe the contact of a solid surface with any liquid. The term “oleophobic/philic” is used with regard to wetting by oil and organic liquids.

As used herein, unless the context indicates otherwise, the term “composite interface” or “composite surface” is an interface (or surface) that can sustain a metastable Cassie-Baxter wettability state of a liquid. The composite interface generally implies an interface where the surface is in contact with the liquid and air (pockets) that are created due to texturing/patterning and an optional chemical modification of the surface

As used herein, unless the context indicates otherwise, the term “physical modification” is a method of texturing and/or patterning a composite interface or surface to create physically distinguishable and distinct features with topography

As used herein, unless the context indicates otherwise, the term “chemical modification” is a method of altering the surface energy of a composite interface or surface by changing the surface chemistry. This can be achieved through application of an extrinsically applied coating, or intrinsic modification of the solid surface through techniques such as ion implantation or surface alloying.

As used herein, unless the context indicates otherwise, the term “hydrophobicity” is the property of a composite interface or surface whereby a static apparent water contact angle of greater than 90 degrees is observed. In general, this can be extended to other liquids, where the term “-phobicity” implies an apparent contact angle of greater than 90 degrees for that particular liquid in contact with the surface of interest. For example, “oleophobicity” is the property of a surface whereby a static apparent contact angle of greater than 90 degrees is observed for a particular organic liquid (e.g., heptane, toluene).

As used herein, unless the context indicates otherwise, the term “hydrophilicity” is the property of a surface whereby a static apparent water contact angle of less than 90 degrees is observed. In general, this can be extended to other liquids, where the term “-philicity” implies an apparent contact angle of less than 90 degrees for that particular liquid in contact with the surface of interest. For example, “oleophilicity” is the property of a surface whereby a static apparent contact angle of less than 90 degrees is observed for a particular organic liquid (e.g., heptane, toluene).

As used herein, unless the context indicates otherwise, the term “omniphobicity” is the property of a surface whereby a static apparent contact angle of greater than 90 degrees is observed for many liquids (aqueous and organic).

As used herein, unless the context indicates otherwise, the term “superhydrophobicity” is the property of a surface whereby a static apparent water contact angle of greater than 150 degrees is observed.

As used herein, unless the context indicates otherwise, the term “micro-patterning” is the creation of texture or pattern on the surface of a solid substrate with features and inter-feature spacing typically on the order of several micrometers to several hundred micrometers.

As used herein, unless the context indicates otherwise, the term “nano-patterning: Creation of texture or pattern on the surface of a solid substrate with features and inter-feature spacing typically on the order of several nanometers to several hundred nanometers.

### Design Approach for Optimal Surface Texture

The basic theory behind solid-liquid surface interactions can be traced back to Young's equation, which gives a simple energy balance to explain how liquids may wet a solid surface. The Young's equation essentially states that wettability is governed entirely by surface energies, or in other words, through surface chemistry. Later on, modifications to Young's equation were provided (by Wenzel and Cassie-Baxter) to incorporate the effects of surface roughness and texturing.

In the Wenzel state, the liquid is in intimate contact with a textured surface. The surface roughness increases the available surface area of solid, thus amplifying the natural wettability state offered by surface chemistry. In this case, a hydrophobic surface becomes more hydrophobic than the original surface without roughness, and similarly, a hydrophilic surface becomes more hydrophilic than the “smooth” surface. In addition, the large contact area between liquid and solid leads to high contact angle hysteresis, defined as the difference between the advancing and receding contact angles. Liquid droplets, thus, do not readily roll off the textured surface. In the Cassie-Baxter (CB) state, air trapped in the grooves between surface features (i.e. a textured or patterned surface) forms a composite (solid/air/liquid) surface. By contrast, the composite interface could produce a hydrophobic surface on otherwise unpatterned/non-textured, hydrophilic substrates, and also facilitates easy droplet roll off. The CB state is thus desirable for many applications such as self-cleaning surfaces and microfluidics.

By minimizing the free energy of a liquid droplet on textured surface, the present disclosure provides a design approach in determining why the droplet “selects” a certain state from the spectrum of possible ones. The result can be visualized in FIG. 1. The composite interface can only be achieved only if anchor points exist on textured surface to capture the moving liquid front. The anchor point is a function of surface topography and the equilibrium Young's angle.

Physically, it is defined by the location at which surface tension forces reaches a balance where local liquid contact angle equals the Young's angle offered by the surface. When the solid surface is hydrophilic (θ_{γ}<90°), the outer surface of the texture or pattern has to curve backward in order to satisfy the Young's angle requirement. This characteristic has been defined as re-entrant surface curvature by other researchers.

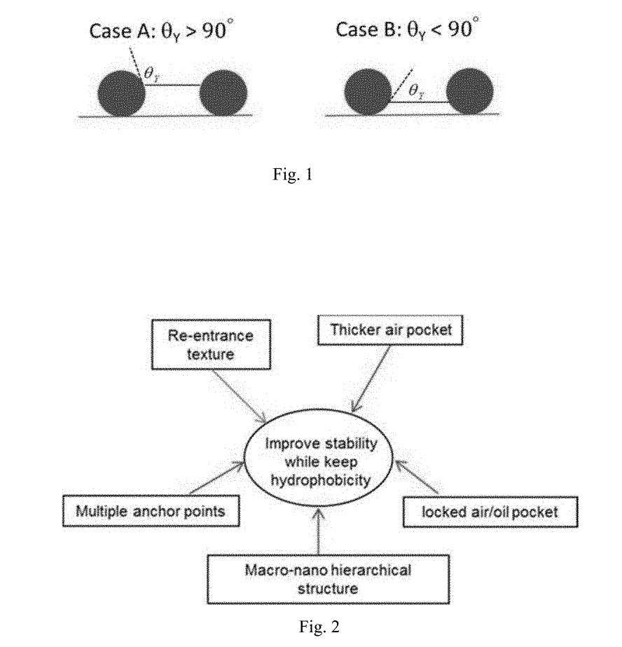

The present disclosure is directed to a surface design approaches to texture surface are shown in FIG. 2: increasing air pocket thickness, multiple anchor points and locked air/oil layer. The present disclosure describes a design tool to produce candidate textures satisfying certain design criteria, and manufacturing schemes to achieve the optimum texture design.

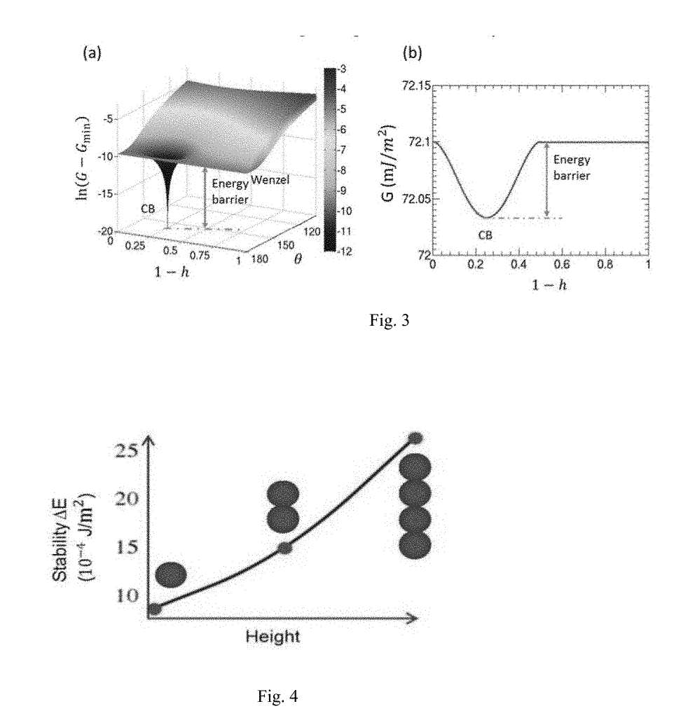

The present disclosure discloses that the method of designing optimum surface texture is based on development of a modeling code (created in MatLab for this particular case) capable of assessing the wettability of a liquid droplet on any given surface texture and surface chemistry. The core engine of the code is to compute the thermodynamic Gibbs free energy of the system by integrating the energy of all surfaces. An exemplary Matlab energy landscape output is shown in FIG. 3. Both Wenzel and CB states are defined by the minimization of the Gibbs energy. In addition, the energy barrier between these two states is an important parameter indicating surface texture stability.

In certain exemplary embodiments, the next step is to identify candidate surface texture designs to achieve stable composite interfaces for various liquids (high and low surface tension). A “snowman” structure is an example of one such proposed structure with multiple spheres stacked on top of each other. As illustrated in FIG. 4, the “snowman” structure can not only produce the composite interface but also increase the energy barrier to break down the composite interface. Furthermore, even if the liquid front dynamically manages to break away from the anchor point of the top sphere, the re-entrant curvature of lower spheres will provide additional anchor points.

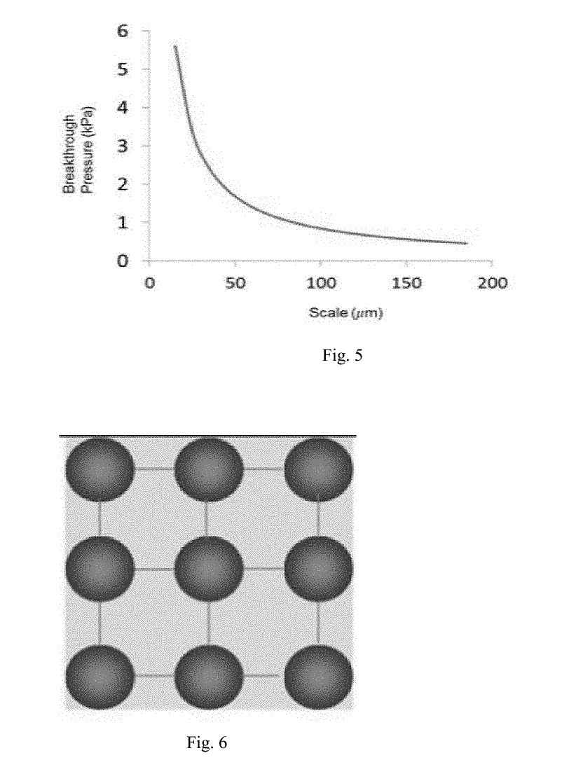

In certain exemplary embodiments, the process further comprises increasing composite interface pressure tolerance by reducing the length scale of structure texture features. Breakthrough pressure is defined as the critical external pressure to force a composite interface to transition irreversibly from a composite Cassie-Baxter state to the fully wetted Wenzel interface. In addition to the energy barrier, the modeling approach used herein postulates that the breakthrough pressure is inversely proportional to the length scale of the surface texture, as shown in FIG. 5. Quantitatively, roughly one tenth of a micron meter size texture is required to withhold one atmosphere of external pressure application.

The present disclosure further discloses that the stability of the composite interface can be further enhanced by locked air/oil pocket as shown in FIG. 6. Because oil is less compressible and has a higher viscosity than air, a locked oil pocket can be more effective. However, the effect of multiple liquids on the overall wettability is not straightforward; thus, an air pocket design may be a simpler approach to further control the wetting state in single phase liquid(s).

### Methods of Making the Optimal Surface Texture

The present disclosure further describes the method of making the optimal surface texture (as described above) using various techniques, including but not limited to, additive manufacturing (AM) and lithographic etching (described below)

1. Additive Manufacturing (AM)

AM or 3D printing describes the technique to make a three dimensional solid object by laying down successive layers of material. The characteristic of this technique is its flexibility in handling both the shape and materials of the products. Today, the additive manufacturing is used to make complex monolithic structures, with application mainly in the aerospace and medical industries.

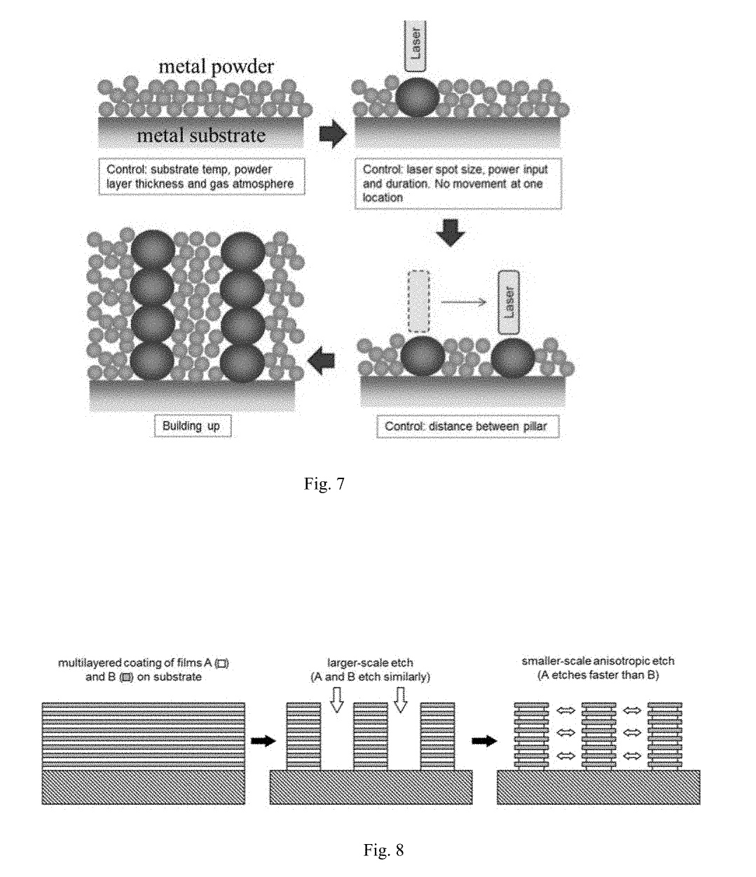

The present description provides methods of fabricating metal surface textures on the scale of several tens of micrometers to several hundred micrometers, using additive manufacturing. In AM, the length scale is limited by either the feedstock powder size or diameter of laser beam. Typically, powder particle sizes range from 20-80 micrometers, while the smallest diameter of the laser beam can be around 50 micrometers (depending upon the power input and traveling speed of the laser). Thus, the practical limits of feature sizes that can be created with AM techniques are around 50 micrometers. Consequently, the minimum curvature can be achieved using AM is around 500 micrometers. According to the present disclosure, the natural shape of the melt metal droplet can be leveraged to fabricate the desired surface texture with re-entrant feature. This concept is schematically shown in FIG. 7. Usually, while the slow metal deposition rate of AM is a concern for creation of 3D objects, a much smaller barrier in productivity is expected for fabrication of 2D features in the present disclosure.

2. Lithography-Based Method for Creating Features with Textured Sidewalls for Increased Pressure Stability

Patterned surfaces are routinely created using lithography and etching. Some etching procedures are isotropic, while others are anisotropic or directional. For a given procedure, different materials etch at different rates and/or degrees of isotropy. The concept being described here is to use a multi-layered coating in which the layers have different etch rates under certain conditions. The present description provides methods of fabricating shown diagrammatically in FIG. 8, wherein the base substrate is (1) initially coated with alternating layers of materials A and B, (2) etched using a nominally isotropic method to create the primary pattern, such as pillars, and then (3) etched using a chemically selective or anisotropic method to reveal a texture on the scale of the A/B layer thickness on the sidewalls of the primary pattern. Steps (2) and (3) can be a single serial process or iterative, depending the materials and etch method employed. The description further provides that the lithography-based method including steps of coating with alternative layers of materials A and B, wherein materials A and B are chosen from a group of materials consisting of silicon, silicon nitride, silicon dioxide, other ceramic oxides, carbides, borides, sulfides, fluorides, nitrides, and metallic materials, and materials A and B have different etching rate under certain conditions; etching using a nominally isotropic method to create a primary pattern on the vertical directions of the layers of materials A and B; and etching using a anisotropic method to reveal a texture on the scale of the A/B layer thickness on the sidewalls of the primary pattern.

3. Coaxial, Porous Pipe-Liner to Modify Pressure Stability

The Cassie-Baxter state typically assumes that the pressure of the gas phase is initially at atmosphere. The pressure of the gas contributes to the radius of curvature at the gas/liquid interface and the theoretical stability that interface. It is also generally assumed that once the Cassie-Baxter state has collapsed, there is no way to reintroduce the gas-phase layer.

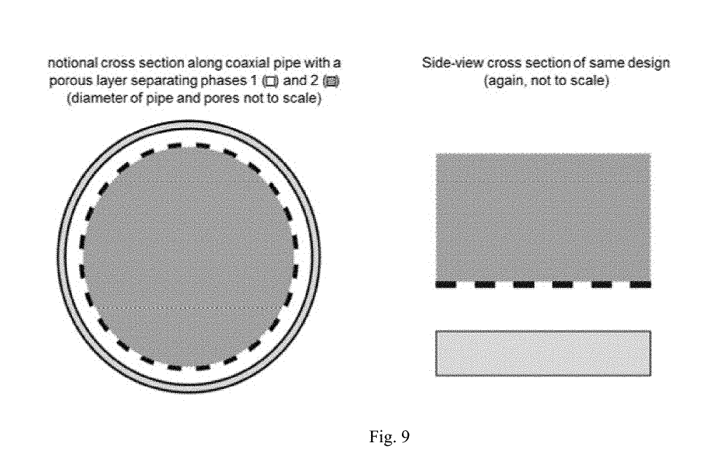

This concept describes a coaxial, two-layer tube or pipe in which a porous and/or patterned intermediary is used to modify wetting, adsorption, or flow of the media in the inner channel by varying the media and/or pressure of media in the outer channel (FIG. 9). For instance, the stability of a Cassie-Baxter-type interface, for the case where the outer channel contains air and the inner channel water separated by micron-scale porous layer or mesh, could be modified by varying the pressure of the air in the channel.

### Surface Texture Design and Method of Making

FIG. 9 further provides an exemplary embodiment of a design workflow of textured and/or patterned surfaced (D1). The design approach assesses the solid surface energy and the liquid surface tension, and incorporates these properties into MatLab model for optimal texture/feature design through calculating the composite surface stability, energy barrier for transition in wettability from CB to Wenzel states.

In one aspect, the description provides a method of designing a composite interface for manipulating wettability of a single liquid when in contact with the surface including steps of calculating stable thermodynamic energy associated with different wettability states; integrating the stable thermodynamic energy of all surfaces; identifying the candidate surface texture to achieve the composite interfaces; and increasing composite interface pressure tolerance by at least one of reducing the length scale of structure texture features, increasing liquid/air interface anchor points, or introducing locked air pockets.

In certain embodiments, the method further comprises identifying the height, shape, and spacing of the candidate surface texture. In certain embodiments, the method further comprises the step of assessing the candidate surface texture; and/or selecting a manufacturing method to produce the candidate surface texture.

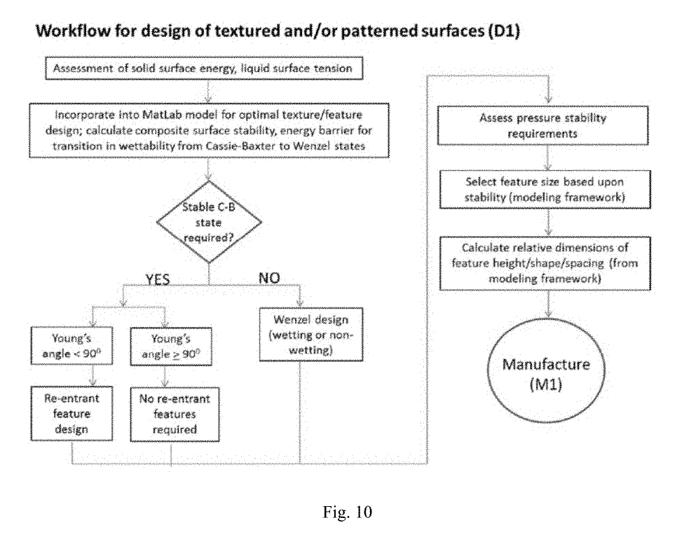

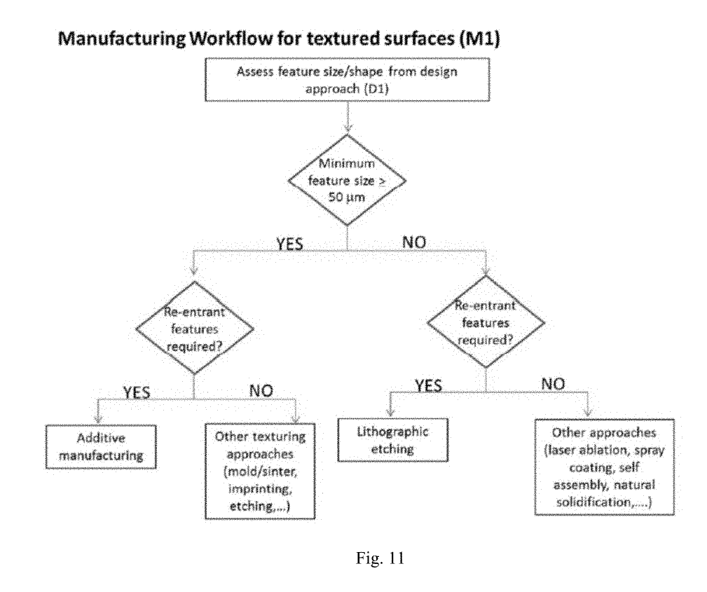

FIG. 10 further provides an exemplary embodiment of manufacturing workflow for textured surfaces (M1). The selection of a manufacture method depends on the design criteria. For example, for a surface with a minimum feature size of 50 μm, manufacture method is selected from additive manufacturing, mold/sinter, imprinting, or etching methods, and preferably additive manufacture method if re-entrant features is required; on the other hand, for a surface with a maximum feature size of 50 μm, manufacturing method can be selected from lithographic etching, laser ablation, spray coating, self-assembly, or natural solidification, among those lithographic etching is preferred if re-entrant features is required.

In one aspect, the description provides a method of producing a composite interface for manipulating wettability of a single liquid in contact with that surface including the design steps as described in FIG. 9, including steps of calculating stable thermodynamic energy associated with different wettability states; integrating the stable thermodynamic energy of all surfaces; identifying the candidate surface texture to achieve the composite interfaces; increasing composite interface pressure tolerance by reducing the length scale of structure texture features, increasing liquid/air interface anchor points, and/or introducing locked air pockets; and fabricating the candidate surface texture using one of the manufacturing methods as described in FIG. 10.

In certain embodiments, the method of producing a composite interface for manipulating wettability of a single liquid in contact with that surface, in which the identifying the candidate surface texture step further comprises identifying the height, shape, and spacing of the candidate surface texture.

In certain embodiments, the method of producing a composite interface for manipulating wettability of a single liquid in contact with that surface, in which the candidate surface texture comprises multiple spherical features stacking on top of each other.

In certain embodiments, the candidate surface texture has a minimum feature size of 50 μm. In certain embodiment, the candidate surface texture with a minimum feature size of 50 μm is fabricated using an additive manufacturing method.

In another embodiments, the candidate surface texture has a maximum feature size of 50 μm. In certain embodiment, the candidate surface texture with a maximum feature size of 50 μm is fabricated using a lithography-based method. The description further provides that the lithography-based method including steps of coating with alternative layers of materials A and B, wherein materials A and B are chosen from a group of materials consisting of silicon, silicon nitride, silicon dioxide, other ceramic oxides, carbides, borides, sulfides, fluorides, nitrides, and metallic materials, and materials A and B have different etching rate under certain conditions; etching using a nominally isotropic method to create a primary pattern on the vertical directions of the layers of materials A and B; and etching using a anisotropic method to reveal a texture on the scale of the AB layer thickness on the sidewalls of the primary pattern.

In another embodiment, the description provides a composite interface produced according to the methods described above, including, e.g., the surface texture with an array of multiple spherical features stacked on top of each other.

In another embodiment, the description provides an article with at least one surface prepared according to the methods described above, with the ability to yield a static contact angle with a single liquid between 0 degrees and about 170 degrees, preferably with the ability to yield a stable static contact angle between about 10 degrees and about 170 degrees between an applied pressure range from about 1 psi to about 5000 psi.

In yet another embodiment, the description provides a machine with at one surface prepared according to the methods described above, with the ability to yield a static contact angle with a single liquid between 0 degrees and about 170 degrees, preferably with the ability to yield a stable static contact angle between about 10 degrees and about 170 degrees between an applied pressure range from about 1 psi to about 5000 psi.

### EXAMPLES

The embodiments described above in addition to other embodiments can be further understood with reference to the following example:

### Example 1

This example illustrates a stable CB composite interface using snowman surface texture.

The snowman surface texture was fabricated using AM technology. The AM machine was a commercially available EOS M280 equipped with a laser head in 1060-1100 nm wavelength and the laser beam size 50 μm. The material of both substrate and metal powder was selected as IN718. The metal powder had average particle size at 30 μm according to cross section metallagraphic analysis. The substrate was heated up to 80° C. before starting the building process and the 80° C. constant temperature was maintained during the building. The AM chamber was back filled with inert Ar gas.

The building mode of EOS M280 was selected as edge mode. The power input of laser beam was 80 W and the traveling speed of laser beam was 1100 mm/s. The surface texture was built up layer by layer. The metal powder thickness for each layer was 80 μm and 4 layers of powder was used to fabricate the snowman texture.

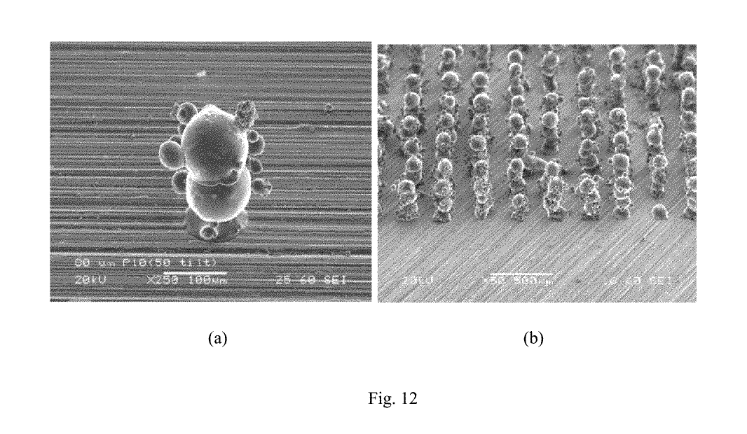

The shape of the snowman surface texture can be confirmed using SEM by tilting the centerline of snowman texture away from the electron beam. FIG. 12(a) shows the side view of single snowman structure under 50° tilt. FIG. 12(b) shows a edge of 7225 snowman texture in a square array and center to center distance 300 μm.

The wettability of snowman textured surface can be determined using a contact angle device. The water contact angle on a flat IN718 is 81 degrees. The value increased to 133 degrees after modifying the surface using snowman texture, which confirmed that the snowman texture stabilized CB composite surface.

### PCT/EP Clauses:

1. A method of designing a composite interface for manipulating wettability of a single liquid when in contact with the surface, calculating stable thermodynamic energy associated with different wettability states; integrating the stable thermodynamic energy of all surfaces; identifying the candidate surface texture to achieve the composite interfaces; and increasing composite interface pressure tolerance by reducing the length scale of structure texture features, increasing liquid/air interface anchor points, and/or introducing locked air pockets.

2. The method of clause 1, wherein the step of identifying the candidate surface texture further includes identifying the height, shape, and spacing of the candidate surface texture.

3. The method of clause 1 or 2, further comprising a step of assessing the candidate surface texture.

4. The method of any of clauses 1-3, further comprising a step of selecting a manufacturing method to produce the candidate surface texture.

5. A method of manufacturing a composite interface for manipulating wettability of a single liquid when in contact with the surface, calculating stable thermodynamic energy associated with different wettability states; integrating the stable thermodynamic energy of all surfaces; identifying the candidate surface texture to achieve the composite interfaces; increasing composite interface pressure tolerance by reducing the length scale of structure texture features, increasing liquid/air interface anchor points, and/or introducing locked air pockets; assessing the candidate surface texture; selecting a manufacturing method to produce the candidate surface texture; and fabricating the candidate surface texture using the manufacturing method.

6. The method of clause 5, wherein identifying the candidate surface texture further includes identifying the height, shape, and spacing of the candidate surface texture.

7. The method of any one of clauses 5-6, wherein the surface texture comprises multiple spherical features stacking on top of each other.

8. The method of any one of clauses 5-7, wherein the candidate surface texture has a minimum feature size of 50 μm.

9. The method of any one of clauses 5-7, wherein the candidate surface texture has a maximum feature size of 50 μm.

10. The method of any one of clauses 5-8, wherein the method further includes a step of fabricating the candidate surface texture using an additive manufacturing method.

11. The method of clause 10, wherein the lithography-based method further includes the steps of coating with alternative layers of materials A and B, wherein materials A and B are chosen from a group of materials consisting of silicon, silicon nitride, silicon dioxide, other ceramic oxides, carbides, borides, sulfides, fluorides, nitrides, and metallic materials, and materials A and B have different etching rate under certain conditions; etching using a nominally isotropic method to create a primary pattern on the vertical directions of the layers of materials A and B; and etching using a anisotropic method to reveal a texture on the scale of the AB layer thickness on the sidewalls of the primary pattern.

12. The use of composite interface for manipulating wettability of a single liquid when in contact with the surface according to clause 1.

13. The use of composite interface for manipulating wettability of a single liquid when in contact with the surface according to clause 5.

14. The use according to any one of clauses 1-10, in which the composite interface is a component of an article, machine, device or system, and in which the use is directed to decelerating corrosion, modifying drag in a pipe, and improving heat transfer efficiency.

15. An article or a machine prepared produced according to any of clauses 1-14.

While preferred embodiments of the invention have been shown and described herein, it will be understood that such embodiments are provided by way of example only and are not meant to be limiting examples. Numerous variations, changes and substitutions will occur to those skilled in the art without departing from the spirit of the invention. Accordingly, it is intended that the appended claims cover all such variations as fall within the spirit and scope of the invention. All such alternative embodiments may be covered by the scope of the invention to the extent where the stability of the resulting composition is not substantially affected.

Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A method of designing a composite interface for manipulating wettability of a single liquid when in contact with the surface, comprising:
a. calculating stable thermodynamic energy associated with different wettability states;
b. integrating the stable thermodynamic energy of all surfaces;
c. identifying the candidate surface texture to achieve the composite interfaces; and
d. increasing composite interface pressure tolerance by reducing the length scale of structure texture features, increasing liquid/air interface anchor points, and/or introducing locked air pockets.

2. The method of claim 1, wherein identifying the candidate surface texture further comprises identifying the height, shape, and spacing of the candidate surface texture.

3. The method of claim 1, further comprising:
assessing the candidate surface texture.

4. The method of claim 3, further comprising
selecting a manufacturing method to produce the candidate surface texture.

5. A composite interface produced according to the method of claim 1, wherein the surface texture comprises an array of multiple spherical features stacked on top of each other.

6. An article prepared according to the method of claim 1, wherein the article has a static contact angle with a single liquid between 0 degrees and about 170 degrees.

7. An article prepared according to the method of claim 1, wherein the article has a stable static contact angle between about 10 degrees and about 170 degrees between an applied pressure range of from about 1 psi to about 5000 psi.

8. A method of producing a composite interface for manipulating wettability of a single liquid in contact with that surface, comprising:
a. designing a candidate surface texture, which comprises:
i. calculating stable thermodynamic energy associated with different wettability states;
ii. integrating the stable thermodynamic energy of all surfaces;
iii. identifying the candidate surface texture to achieve the composite interfaces; and
iv. increasing composite interface pressure tolerance by reducing the length scale of structure texture features increasing liquid/air interface anchor points and introducing locked air pocket;
b. assessing the candidate surface texture;
c. selecting a manufacturing method to produce the candidate surface texture; and
d. fabricating the candidate surface texture using the manufacturing method.

9. The method of claim 8, wherein identifying the candidate surface texture further comprises identifying the height, shape, and spacing of the candidate surface texture.

10. The method of 8, wherein the candidate surface texture comprises multiple spherical features stacking on top of each other.

11. The method of claim 8, wherein the candidate surface texture has a minimum feature size of about 50 μm.

12. The method of claim 11, further comprising fabricating the candidate surface texture using an additive manufacturing method.

13. The method of claim 8, wherein the candidate surface texture has a maximum feature size of about 50 μm.

14. The method of claim 13, further comprising fabricating the candidate surface texture using a lithography-based method.

15. The method of producing a composite interface of claim 14, wherein the lithography-based method comprising:
a. coating with alternative layers of materials A and B, wherein materials A and B are chosen from a group of materials consisting of silicon, silicon nitride, silicon dioxide, other ceramic oxides, carbides, borides, sulfides, fluorides, nitrides, and metallic materials, and materials A and B have different etching rate under certain conditions;
b. etching using a nominally isotropic method to create a primary pattern on the vertical directions of the layers of materials A and B; and
c. etching using a anisotropic method to reveal a texture on the scale of the AB layer thickness on the sidewalls of the primary pattern.

16. An article having a composite interface produced according to the method of claim 8.

17. An article having a composite interface produced according to the method of claim 15.

18. An article or a machine prepared according to the method of claim 8, with the ability to yield a static contact angle with a single liquid between 0 degrees and 170 degrees.

19. An article or a machine prepared according to the method of claim 8, with a stable static contact angle between 10 degrees and 170 degrees between an applied pressure range from 1 psi to 5000 psi.
